(19) United States
(12) Patent Application Publication
(10) Pub. No.: US 2026/0297475 A1
(43) Pub. Date: Oct. 1, 2026

(54) CLARIFYING AGENTS

(71) Applicant: PQ LLC, Malvern, PA (US)

(72) Inventors: Simon Stebbing, Cheshire (GB); Miguel Monsanto, Selfkant (DE); Philippe Cario, Chaumes en Brie (FR)

(73) Assignee: PQ LLC, Malvern, PA (US)

(21) Appl. No.: 19/476,527

(22) PCT Filed: Apr. 19, 2024
(86) PCT No.: PCT/US2024/025422

§ 371 Date: Oct. 17, 2025

(30) Foreign Application Priority Data
Apr. 21, 2023 (GB) 2305914.0

(51) Int. Cl. C12C 7/24; B01J 20/10; B01J 20/28; C12H 1/044

(52) U.S. Cl. CPC C12C 7/24; B01J 20/103; B01J 20/28004; B01J 20/28016; B01J 20/28047; B01J 20/28061; B01J 20/28064; B01J 20/28071; B01J 20/28073; B01J 20/28076; C12H 1/0408

(57) ABSTRACT

Described is the use of porous silica gel particles or porous precipitated silica particles in treating a wort, wherein the porous silica particles have a water content of 30% by weight or less and a pore volume of 0.4 ml/g or more. Methods of treating a wort and methods of preparing a beverage are also described.

### FIELD OF INVENTION

The present invention relates to use of porous silica particles in treating a wort, a method of treating a wort, and to a method of preparing liquid beverages.

### BACKGROUND

It is well known that the brewing process often results in beverages, such as beer, that have high levels of haze. This haze can be undesirable for certain end consumer products, where the customer may desire a clear product.

In typical processes, beverages obtainable from a wort, such as beer, are clarified after fermentation in the cold block by treatment with a colloidal stabilizer agent. These agents are then removed from the end product by filtration. Various clarifying agents have been employed in the art for such post-production clarification and for instance it is known to use silica hydrogels for this purpose. Although less frequently employed, beer producers are also known to add finings agents to the wort prior to fermentation. These agents have the effect of coagulating coarse particles and/or removing at least some haze from the wort. Exemplary finings agents include Carrageenan, tannic acid, polyvinylpolypyrrolidone (PVPP), gelatine, isinglass, egg whites, casein, bentonite and carbon. Mixtures of materials are also employed such as the combination of Carrageenan and PVPP (e.g. Polyclar™ produced by Ashland Global Specialty Chemicals Inc), Carrageenan and silica sol (e.g. GB2280908A), Carrageenan and a carbohydrate (e.g. U.S. Pat. No. 6,045,852A), or silica hydrogel and PVPP (e.g. PolyGel BH supplied by AEB group). It is also known, e.g. in U.S. Pat. No. 8,697,169B2, to use silica sol independently as a finings agent. Silica sol is essentially a stable aqueous suspension of colloidal non-porous silica particles.

However, the above-mentioned strategies suffer from several disadvantages such as insufficient clarification and/or the requirement for additional processing steps and/or reduced efficiency of the overall process. For instance, not all breweries have the space for cold block filtration and moreover filtration to remove fines can often reduce efficiency, for instance because of filter blockages/increases in back pressure on the filter which can reduce throughput.

The above issues are also encountered by producers of non-fermented beverages obtainable from wort, where a clearer product is desirable.

Accordingly, it would be of benefit for there to be alternative and/or improved methods of producing beverages obtainable from wort having desirable levels of clarity.

### SUMMARY OF THE INVENTION

At a general level, the invention proposes the novel use of particular porous silica particles for treating a wort, with surprisingly advantageous benefits. In particular, it has been found to be possible to reduce the haze and, in certain embodiments, also the protein content of a wort using porous silica gel particles or porous precipitated silica particles as described herein. The use of these silicas has been found to offer distinct advantages over prior art processes such as those described above, e.g. compared to the use of silica sols.

Advantageously, the use of the silica particles described herein has been found to provide a significant reduction in the haze of the wort at comparatively low loadings (see examples).

Advantageously, some embodiments of the present invention have also been found to reduce the amount of sensitive proteins present. It will be appreciated that by the term “sensitive proteins”, it is meant the fraction of proteins which are tannic acid precipitable. The amount of sensitive proteins is therefore determined by measurement of the haze formed (EBC units) after the addition of a specific amount of tannic acid as described in the method section below. The reduction in sensitive protein may allow the brewery to reduce or avoid the need for stabilising the beer after fermentation. This is particularly advantageous for smaller breweries that do not have a possibility to stabilize and filter in the cold block or breweries that want to avoid process bottlenecks at a late stage of the process which can reduce throughput of the final product.

The reduction in haze and protein content also has further advantages. Wort treated with silica particles according to the present invention have shown the potential to spend less time in the whirlpool stage of the process while producing a more compact trub leading to yield improvements.

Moreover, it has unexpectedly been observed that using the method according to the present invention results in an improvement in the subsequent filtration of the fermented beer obtained from the treated wort. Using the porous silica particles within a brewing process as described herein has for instance been shown to result in less charge going to the filter, and therefore less pressure build up on filter over longer filtration runs. For example, as described below, it was found to be possible to filter about two times the beer volume in the same run compared to beer fermented from a wort that had not been treated with porous silica particles of the invention.

As a result, the use of the silica particles described herein has been found to provide high levels of haze reduction, and in some embodiments, high levels of sensitive protein removal, even when used at a low dosage, whilst also delivering practical benefits in terms of processability. The use of the silica particles described herein can therefore improve the overall efficiency of a brewing process.

Further, the methods described can provide reduced waste compared to traditional brewing methods involving clarification after fermentation. For example, the silica particles used can be separated with the spent grains of the wort and used in animal feed or sent to methanisation (biogas) plants. In traditional methods involving clarification in the cold block, a separate waste product is produced.

In a first aspect of the invention there is provided the use of porous silica gel particles or porous precipitated silica particles in treating a wort, wherein the porous silica particles have a water content of 30% by weight or less and a pore volume of 0.4 ml/g or more. It will be appreciated in this context that “the porous silica particles” refers to the porous silica gel particles and porous precipitated silica particles mentioned.

The term “wort” is well known in the art and is intended to be given its conventional meaning. The term for instance includes the liquid extracted from grains obtained during the mashing step of a brewing process. For example, wort obtained from the brewing of beers such as lager, pilsner, Dortmund and Munich beers as well as top fermented beverages such as ale, porter and stout. The wort typically contains proteins in addition to the sugars, e.g. maltose, that will (in the case of fermented products) be fermented by yeast to produce a fermented beverage. The wort may for example be a full malt brew, or may be a partial malt brew with adjuncts, e.g. 60% malt with 40% adjuncts.

Reference to the “water content” of the particles refers to the water content of the particles before being added to the wort in the process. The water content may be calculated by the method for “Determining water content” described below in the general methods section.

As mentioned above, the method has advantageously been shown to result in large reductions in the levels of haze and in some embodiments also protein. This reduction may avoid the need for further processing after fermentation and can improve efficiencies in the whirlpool and filtration stages of the brewing process, leading to a more optimised brewing process.

In a second aspect of the invention there is provided a method for treating a wort comprising contacting the wort with porous silica gel particles or porous precipitated silica particles, wherein the porous silica particles have a water content of 30% by weight or less and a pore volume of 0.4 ml/g or more. It will be appreciated in this context that “the porous silica particles” refers to the porous silica gel particles and porous precipitated silica particles mentioned.

In a third aspect of the invention there is provided a method of preparing a beverage comprising: treating grains to produce a wort; contacting the wort with porous silica gel particles or porous precipitated silica particles; and using the resulting wort to produce the beverage; wherein the porous silica particles have water content of 30% by weight or less and a pore volume of 0.4 ml/g or more. It will be appreciated in this context that “the porous silica particles” refers to the porous silica gel particles and porous precipitated silica particles mentioned.

As will be appreciated based on the present specification and advantages described herein (and demonstrated by the examples), treating a wort according to the present uses and methods has the effect of reducing the haze of the wort (according to the haze value determined by the methods described herein) and may in embodiments also reduce protein levels in the wort, particularly levels of sensitive proteins (as also described further herein). Thus, in the uses and methods described herein, treating a wort may be use in, or a method of, reducing the haze of the wort and, optionally, reducing the protein content of the wort.

Thus provided is the use of porous silica gel particles or porous precipitated silica particles in reducing the haze of a wort (and optionally also the protein content of the wort), wherein the porous silica particles have a water content of 30% by weight or less and a pore volume of 0.4 ml/g or more. It will be appreciated in this context that “the porous silica particles” refers to the porous silica gel particles and porous precipitated silica particles mentioned.

Also provided is a method for reducing the haze of a wort (and optionally also the protein content of the wort) comprising contacting the wort with porous silica gel particles or porous precipitated silica particles, wherein the porous silica particles have a water content of 30% by weight or less and a pore volume of 0.4 ml/g or more. It will be appreciated in this context that “the porous silica particles” refers to the porous silica gel particles and porous precipitated silica particles mentioned.

It will also be appreciated in methods of preparing a beverage as provided by the third aspect of the invention and its embodiments, that contacting the wort with the porous silica gel particles or porous precipitated silica particles has the effect of reducing the haze of the wort (according to haze value determined by the methods described herein) and may in embodiments also reduce protein levels in the wort, particularly levels of sensitive proteins (as also described further herein). Thus, also provided is a method of preparing a beverage comprising: treating grains to produce a wort; contacting the wort with porous silica gel particles or porous precipitated silica particles to reduce the haze of the wort (and optionally also reduce the protein content of the wort); and using the resulting wort to produce the beverage; wherein the porous silica particles have water content of 30% by weight or less and a pore volume of 0.4 ml/g or more. It will be appreciated in this context that “the porous silica particles” refers to the porous silica gel particles and porous precipitated silica particles mentioned.

### DETAILED DESCRIPTION

Embodiments of the various aspects of the invention are described below. For the avoidance of doubt, it will be appreciated, where appropriate, that any embodiments as described herein in relation to one aspect of the present invention will also apply to the other aspects of the present invention.

Unless indicated herein to the contrary, properties attributed to “the porous silica particles” in the statements of invention and claims refers to the porous silica gel particles and porous precipitated silica particles mentioned.

According to the invention, the porous silica particles (i.e. the porous silica gel particles and porous precipitated silica particles) may have a pore volume of 0.6 ml/g or more, such as 0.75 ml/g or more, or 0.8 ml/g or more. The porous silica particles may have a pore volume of 2 ml/g or less. Accordingly, the porous silica particles (i.e. the porous silica gel particles and porous precipitated silica particles) may have a pore volume of from 0.6 ml/g to 2 ml/g.

The porous silica particles (i.e. the porous silica gel particles and porous precipitated silica particles) may have a pore volume of 1.0 ml/g or more. For example, the porous silica particles may have a pore volume of from 1 ml/g to 2 ml/g. The porous silica particles may have a pore volume of 1.8 ml/g or less. Accordingly, the porous silica particles (i.e. the porous silica gel particles and porous precipitated silica particles) may have a pore volume of from 1 ml/g to 1.8 ml/g. The porous silica particles may have a pore volume of from 1.0 ml/g to 1.2 ml/g.

As shown in the examples below, increasing the pore volume has been observed to affect the levels of haze reduction obtainable as well as reduction in sensitive protein levels. As shown in tables 2 and 5, pore volumes above 1.0 ml/g show an improvement over the examples tested having pore volumes below this value. Particularly advantageous results are obtained using pore volumes between 1.0 and 1.8 ml/g, where the tested examples show particular improvements in both haze and sensitive protein reduction relative to comparatively lower or higher pore volumes.

The porous silica particles (i.e. the porous silica gel particles and porous precipitated silica particles) may have a pore volume of 1.2 ml/g or more. The porous silica particles may have a pore volume of from 1.2 ml/g to 2 ml/g. The porous silica particles may have a pore volume of from 1.2 ml/g to 1.8 ml/g. The porous silica particles may have a pore volume of from 1.2 ml/g to 1.3 ml/g, for example, a pore volume of about 1.28 ml/g. The porous silica particles may have a pore volume of 1.5 ml/g or more, for example, the porous silica particles may have a pore volume of from 1.5 ml/g to 2 ml/g. The porous silica particles may advantageously have a pore volume of from 1.5 ml/g to 1.8 ml/g. The porous silica particles may have a pore volume of 1.6 ml/g or more. The porous silica particles may have a pore volume of from 1.6 ml/g to 1.8 ml/g, for example about 1.7 ml/g.

In some embodiments, the porous silica particles may have a pore volume of 1.75 ml/g or more, such as 1.8 ml/g or more. In other embodiments, the porous silica particles have a pore volume of 1.75 ml/g or less, such as 1.6 ml/g or less, such as 1.5 ml/g or less. Optionally, the bottom end of these ranges may be a pore volume of 1.0 ml/g.

The porous silica particles (i.e. the porous silica gel particles and porous precipitated silica particles) may have a water content of 20% by weight or less. The porous silica particles may have a water content of 15% by weight or less, such as 10% by weight or less. The porous silica particles may have a water content of 7.5% by weight or less. The porous silica particles may have a water content of 5% by weight or less. The porous silica particles may have a water content of from 1% to 10% by weight. The porous silica particles may have a water content of from 2% to 6% by weight. The porous silica particles may have a water content of from 2% to 4% by weight.

As mentioned above, and shown in table 1, it has been found that the use of silica particles with a water content below 30%, provides greater clarification compared to the same dosage of silica particles having a higher water content. Using silica particles with a low water content has also been found to provide improvements in the overall processing efficiency and ease of handling.

Advantageously, the porous silica particles of the invention described herein provide excellent results without the need for additional fining agents. Accordingly, in embodiments, the silica particles may be used (in the methods and uses described herein) in the absence of other fining/clarifying agents, such as in the absence of polyvinylpolypyrrolidone (PVPP), and/or in the absence of carrageenan or tannic acid.

As noted herein, the uses and methods of the invention may use porous silica gel particles or porous precipitated silica particles having water content of 30% by weight or less and a pore volume of 0.4 ml/g or more. Both porous silica gel particles and porous precipitated silica particles may be present, or solely porous silica gel particles, or solely porous precipitated silica particles. The porous silica particles may thus be porous silica gel particles. For example, the porous silica particles may be porous silica xerogel particles. Alternatively, the porous silica particles may be porous precipitated silica particles. Both types of particles have been shown to be particularly effective at reducing haze of a wort, as evidenced by the examples below.

The porous silica particles (i.e. the porous silica gel particles and porous precipitated silica particles) may have a surface area of 800 m²/g or less, such as 700 m²/g or less, or 600 m²/g or less. The porous silica particles may have a surface area of 500 m²/g or less, for example, 450 m²/g or less. The porous silica particles may have a surface area of 200 m²/g or more. Accordingly, the porous silica particles may have a surface area of from 200 m²/g to 800 m²/g. Preferably the porous silica particles have a surface area of from 200 m²/g to 500 m²/g.

The porous silica particles may be used in an amount of 1 g to 50 g per 100 litres of wort, such as 5 g to 20 g, or 10 g to 30 g per 100 litres of wort. The porous silica particles may be used in an amount of no more than 25 g per 100 litres of wort, e.g. at around 20 g per 100 litres of wort. Advantageously, the silica particles described herein have been found to provide a significant reduction in the haze of the wort even at comparatively low loadings, leading to excellent efficiency (see table 4 in examples below). The ability to use a lower silica content to achieve desirable haze and/or protein levels is also expected to result in downstream processing benefits since less finings material must then be removed from the product. Thus, the porous silica particles may be used in an amount of no more than 20 g per 100 litres of wort. The porous silica particles may be used in an amount of no more than 15 g per 100 litres of wort, no more than 10 g per 100 litres of wort or no more than 8 g per 100 litres of wort. The porous silica particles may be used in an amount of 1 g to 15 g per 100 litres of wort, such as 1 g to 10 g, or 1 g to 8 g, or 1 g to 5 g per 100 litres of wort.

The porous silica particles may have a weight median particle diameter (D50) of 1 μm or more. The porous silica particles may have a weight median particle diameter (D50) of 2.5 μm or more. The porous silica particles may have a weight median particle diameter (D50) of 5 μm or more, such as 7.5 μm or more, or 10 μm or more. Advantageously, using particle sizes on the micron scale allows for the silica particles to more easily settle out of solution and therefore be removed from the wort after treatment. This represents an improvement over colloidal silicas.

The porous silica particles may have a weight median particle diameter (D50) of 200 μm or less. The porous silica particles may have a weight median particle diameter (D50) of 150 μm or less, 100 μm or less, 80 μm or less, or 50 μm or less. The porous silica particles have a weight median particle diameter (D50) of 30 μm or less. The porous silica particles have a weight median particle diameter (D50) of 20 μm or less, such as 15 μm or less. Accordingly, the porous silica particles may have a weight median particle diameter (D50) of from 1 μm to 200 μm. Preferably, the porous silica particles have a weight median particle diameter (D50) of from 2.5 μm to 80 μm. The porous silica particles may have a weight median particle diameter (D50) of 5 μm to 50 μm. As shown table 5, silica particles with a higher weight median particle diameter (D50), in particular above 80 μm, have been found to show less sensitive protein reduction compared to silica particles with lower weight median particle diameters (D50).

In a preferred embodiment, the porous silica particles have a pore volume of 1.2 ml/g to 1.3 ml/g, a water content of from 2 to 4% wt, and a weight median particle diameter (D50) of 5 μm to 50 μm. The porous silica particles of this preferred embodiment may be porous silica xerogel particles.

In another preferred embodiment, the porous silica particles have a pore volume of 1.0 ml/g to 1.2 ml/g, a water content of from 2 to 6%, and a weight median particle diameter (D50) of 2.5 μm to 50 μm. The porous silica particles of this preferred embodiment may be precipitated silica particles.

In another preferred embodiment, the porous silica particles have a pore volume of 1.6 ml/g to 1.8 ml/g, a water content of from 2 to 4%, and a weight median particle diameter (D50) of 5 μm to 50 μm. The porous silica particles of this preferred embodiment may be porous silica gel particles, e.g. silica xerogel particles.

According to the invention, the wort may be treated at any suitable point in a beverage preparation process. It will be appreciated that the method is not particularly limited by the location of the wort. For example, contacting the porous silica particles with the wort may occur within a mash tun, a lauter tun, a press filter, a wort kettle, a whirlpool/decanter or a fermenter, or between any two of the above. It also may occur in a different location.

The uses and methods described herein may further comprise allowing the silica particles to settle out of the wort and separating the wort from the silica particles. This allows the silica particles and any adsorbed compounds to be easily removed from the wort.

The uses and methods described herein may further comprise treating grains to produce the wort prior to contacting the wort with the porous silica gel particles or porous precipitated silica particles. The method may further comprises using the resulting wort (i.e. after treatment with the porous silica particles) to produce a beverage. Accordingly, the method may further comprise both treating grains to produce the wort and using the resulting (treated) wort to produce a beverage.

Accordingly, there is provided the method according to the third aspect of the invention.

Methods according to the third aspect or its embodiments may further comprise separating the silica particles from the wort prior to using the resulting wort to produce the beverage. Separating the particles at this stage may improve the downstream processing, for example the pressure on the filter elements.

The silica particles may be separated from the wort together with spent grains produced from treating the grains. Advantageously, this avoids the need for a separate waste stream, allows the particles to be utilised or processed with the spent grains, and improves the efficiency of the clarification process.

Preferably, the method is a method of brewing a fermented beverage and using the resulting wort comprises fermenting the resulting wort. In other words there is provided a method of brewing a fermented beverage comprising: treating grains to produce a wort; contacting the wort with porous silica gel particles or porous precipitated silica particles; and fermenting the resulting wort to produce the fermented beverage; wherein the porous silica particles have water content of 30% by weight or less and a pore volume of 0.4 ml/g or more.

In particularly preferred embodiments, the fermented beverage is a beer.

In some embodiments, the methods or uses described herein result in at least 20% reduction in haze relative to the haze of the wort prior to treatment/contacting with the porous silica particles of the invention. There may be at least 25% reduction in haze. There may be at least 30% reduction in haze. There may be at least 35% reduction in haze. There may be at least 40% reduction in haze. There may be at least 45% reduction in haze. There may be at least 50% reduction in haze. There may be at least 55% reduction in haze. There may be at least 60% reduction in haze. There may be at least 65% reduction in haze. There may be at least 70% reduction in haze. There may be at least 75% reduction in haze. There may be at least an 80% reduction in haze. There may be at least an 85% reduction in haze. There may be at least a 90% reduction in haze. There may for instance be from 20-90%, or 20-50% reduction in haze. Reduction in haze is as determined according to the methods described herein for determining haze reduction levels (see general methods section).

In some embodiments, the methods or uses described herein result in at least 5% reduction in sensitive protein relative to the sensitive protein content of the wort prior to treatment/contacting with the porous silica particles of the invention. There may be at least 10% reduction. There may be at least 15% reduction. There may be at least 20% reduction. There may be at least 25% reduction. There may be at least 30% reduction. There may be at least 35% reduction. There may be at least 40% reduction. There may be at least 45% reduction. There may for instance be from 5-45% reduction in sensitive proteins. Reduction in sensitive proteins is as determined according to the methods described herein for determining sensitive protein reduction levels (see general methods section).

### BRIEF DESCRIPTION OF FIGURES

FIG. 1 is a graph showing haze levels in wort samples after lab scale treatment with different silica gels.

FIG. 2 is a graph showing protein reduction in wort samples after lab scale treatment with low water content silica gels of differing pore volumes.

### GENERAL METHODS

### Determining Water Content

The water content of the silica particles was determined by measuring the weight loss after drying for 4 hours at a temperature of 105° C. and at atmospheric pressure (e.g. using an oven). This method is the standard method used to measure the water content of silica.

### Determining Haze Levels

The haze was measured in a wort sample at room temperature with a Turbidimeter (Hach 2100N) and expressed in EBC 90° haze units. This refers to EBC units measured in a turbidimeter under a 90 degree angle.

Haze reduction was calculated by comparing the haze value (EBC 90° haze units) of a wort sample treated with silica particles with the haze value (EBC 90° haze units) of a reference sample which was not treated with the silica particles. The haze value of the wort sample treated with silica particles was recorded 20 minutes after contacting the silica particles with the wort. The haze value of the reference sample was recorded at the same time (i.e. also after 20 minutes). The formula below was used for the calculation.

$$Haze reduction = \frac{Haze value of reference sample - Haze value of sample}{Haze value of reference sample}$$

In each table, the reference sample used for the calculation is provided as the comparative example.

### Determining Amount of Sensitive Proteins

The presence of sensitive proteins in beverages obtained from wort, such as beer, can have an adverse effect on stability of the beverage. The effect of the porous silica clarifying agents of the invention on reducing sensitive protein was tested. As mentioned above, the amount of sensitive proteins as referenced herein refers to the fraction of proteins which are tannic acid precipitable. More information can be found in K. A. Leiper et al, Optimising Beer Stabilisation by the Selective Removal of Tannoids and Sensitive Proteins”, Journal of the Institute of Brewing, 111 (2), 118-127, 2005.

Sensitive protein was determined using the method described in European Brewery Convention (EBC) Analytica, Section 9.40, Sensitive proteins in beer by nephelometry, Fachverlag Hans Carl, Nurenberg, Germany, 1998. The method was modified by taking the measurements after 30 minutes. In brief, after the haze measurement protocol (described above) was conducted, the haze values were re-measured and 0.1 g/l aqueous tannic acid solution was added to both the wort sample treated with silica particles and to the corresponding reference sample. The amount of precipitated “sensitive proteins” was then measured as an increase in the haze of the wort at defined time (30 minutes) after addition of the tannic acid. In this specific case 20 ml of 0.1 g/l tannic acid solution was added to 180 ml of wort (with stirring). Sensitive proteins are expressed in EBC 90° haze units (Turbidimeter (Hach 2100N)).

Sensitive protein reduction was calculated by comparing the sensitive protein value of a wort sample treated with silica particles with the sensitive protein value of a reference sample which was not treated with the silica particles. The formula below was used for the calculation

$$Sensitive protein reduction = \frac{Value of reference sample - value of sample}{Value of reference sample}$$

In each table, the reference sample used for the calculation is provided as a comparative example.

### Determining Surface Area and Pore Volume

Silica surface area was determined using the standard multi-point nitrogen adsorption method of Brunauer, Emmett and Teller (BET) using an ASAP 2460 apparatus supplied by Micromeritics of USA. The method is consistent with the paper by S. Brunauer, P. H. Emmett and E. Teller, J. Am. Chem. Soc., 60, 309 (1938).

Silica pore volume was determined using the same instrument employing the method described in ASTM D4222-20. Total pore volume was measured from the desorption branch of the isotherm at a partial pressure P/P0 of 0.998.

Xerogel and precipitated silica samples were outgassed under vacuum at 270° C. for 4 hours before either surface area or pore volume measurements at about −196° C. Hydrogel and hydrated xerogel samples were first outgassed for 1 hour at 90° C. and then for four hours at 270° C.

### Determining Pore Diameter

Pore Diameter is a calculated parameter based on an assumption of cylindrical pores. It is determined using from the following equation:

$$Mean Pore Diameter ( in Angstroms ) = \frac{40000 \times Pore Volume ( in {cm}^{3} {g}^{- 1} )}{Surface Area ( in {m}^{2} {g}^{- 1} )}$$

Pore volume and surface area are determined using the methods described above.

### Determining Particle Size

The weight median particle diameter (D(50)) of silica particles was determined by laser diffraction using a Malvern Mastersizer 3000 and a Hydro LV dispersion unit. Mie theory was used to calculate particle size distributions. The real value of the silica refractive index was assigned a value of 1.46 and the imaginary refractive index of the particle was assigned a value of 1.0, with water dispersant having a real refractive index of 1.33. Silica particles were dispersed ultrasonically using the Hydro LV dispersion unit at 50% power for 2 minutes in de-ionised water to form an aqueous suspension. The scattered light intensity was measured as a function of angle and the data used to calculate particle size distribution.

Lab Scale Treatment of Wort with Porous Silica Particles

Samples of wort were obtained during transfer from a wort kettle to a whirlpool (i.e. after boiling of the wort).

Silica particles were added to the hot wort at a set dosage (20 g of silica per 100 L (hectolitre) of wort unless stated otherwise). The typical temperature of a hot wort may be between 7° and 120° C. dependent on the exact brewing process. In the examples described herein, the obtained samples of wort were at around 100° C. when sampled and silica particles were added to the wort samples within around 5 mins of the wort samples being taken. The silica can suitably be dosed directly to the wort or via a dosing vessel. The wort/silica mixture was mixed in a similar movement as the whirlpool of a brewery. Haze measurements (EBC) 90° were taken after a set time period (20 minutes after silica dosing, as stated in the tables below) using the procedures described above. Protein measurements were taken 30 minutes after addition of tannic acid as described in the methods section above Worts tested in the examples were obtained from the following malts/brews:
1. A full malt, 16°P, brew;
2. A full malt brew at 15-16° P;
3. A 60% malt and 40% adjuncts brew, at 18-18.5° P.

As will be understood by the skilled person, the units OP refers to “Degrees Plato”, a conventional term used to quantify the concentration of extract in wort (mainly sugars) as a percentage by weight. As an example a 10° P wort will contain 10 g of extract per 100 g of wort. Information on OP values of the malt were calculated according to routine methods and provided by the respective brewers. A dosage of 20 g/hl (0.2 g/l) was selected as corresponding to a conventional finings dosage.

Industrial Scale Treatment of Wort with Porous Silica Particles

The use of porous silica particles during the production of beer was tested on a larger scale (see Example 33) to observe overall processing benefits. The beer was a 60% malt and 40% adjuncts brew, at 18-18.5°P (wort 3 above). Silica gel was added to the wort in the wort kettle at the beginning of boiling using the hop vessel as a dosing point. Reference brews were also prepared without addition of silica particles to the wort.

### EXAMPLES

The aspects of the present invention will now be further described by various non-limiting examples and with reference to the enclosed figures.

### Haze Measurements on Worts after Treatment with Silica Particles with Differing Water Contents (Examples 1-6)

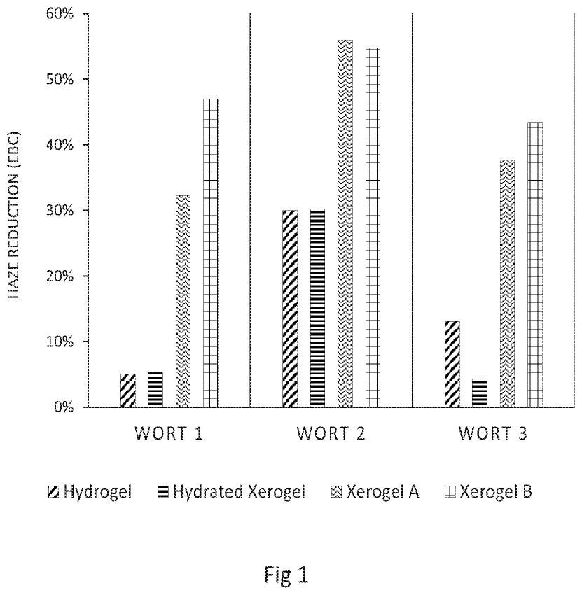

Samples of a wort from three different brews were obtained during transfer from a wort kettle to a whirlpool. The wort was from a full malt 16°P brew (wort 1 above). Each sample was then divided into five sub-samples. One sub-sample of each wort sample was measured without addition of silica particles (comparative examples C1, C4, C7). The remaining 4 samples were treated with different silica particles as described in more detail in the examples (broadly, these can be described as silica hydrogels, hydrated silica xerogels, silica xerogels and high pore volume silica xerogels) at a concentration of 20 g/hl as described in the general methods section above. The results are shown in the table 1 and plotted in FIG. 1.

Many types of silicas useful in the application described herein are known in the art. Suitable silica gels can broadly be divided into two groups, hydrogels and xerogels. Partial drying of a hydrogel can result in a third type, which is referred to herein as a ‘hydrated xerogel’ below. All three gel types can be produced according to conventional methods, such as using similar processes as described in many publications, such as but not limited to U.S. Pat. Nos. 4,515,821; 4,636,394; 5,622,743, 6,555,151 6,565,905 and 10,633,621, the entire subject matter of which is incorporated herein by reference. Means of making suitable precipitated silicas are described in EP0287232 and elsewhere.

Specific physical properties of the respective silica particles tested are presented in the tables below. Comparative examples C2-3, C5-6 and C8-9 are silicas with a water content of above 30 wt % (hydrogels and hydrated xerogels).

TABLE 1

| | | | | | | |
|---|---|---|---|---|---|---|
| | | | | | | Haze |
| | Water | Surface | Pore | Pore | | reduction |
| Silica | Content | Area | Volume | Diameter | D(50) | (EBC 90°) |
| Description | % | (m2/g) | (ml/g) | (Å) | (μm) | 20 mins |

Wort from brew 1

| | | | | | | | |
|---|---|---|---|---|---|---|---|
| C1 | No silica | N/A | N/A | N/A | N/A | N/A | 0% |
| C2 | Hydrogel | 61 | 740 | 1.7 | 92 | 20 | 5% |
| C3 | Hydrated | 35 | 675 | 0.69 | 41 | 15 | 5% |
| | Xerogel | | | | | | |
| 1 | Xerogel A | 2.5 | 300 | 1.55 | 207 | 8.7 | 32% |
| 2 | Xerogel B | 3.8 | 438 | 1.28 | 116 | 13.08 | 47% |

Wort from brew 2

| | | | | | | | |
|---|---|---|---|---|---|---|---|
| C4 | No silica | N/A | N/A | N/A | N/A | N/A | 0% |
| C5 | Hydrogel | 61 | 740 | 1.7 | 92 | 20 | 30% |
| C6 | Hydrated | 35 | 675 | 0.69 | 41 | 15 | 30% |
| | Xerogel | | | | | | |
| 3 | Xerogel A | 2.5 | 300 | 1.55 | 207 | 8.7 | 56% |
| 4 | Xerogel B | 3.8 | 438 | 1.28 | 116 | 13.08 | 55% |

Wort from brew 3

| | | | | | | | |
|---|---|---|---|---|---|---|---|
| C7 | No silica | N/A | N/A | N/A | N/A | N/A | 0% |
| C8 | Hydrogel | 61 | 740 | 1.7 | 92 | 20 | 13% |
| C9 | Hydrated | 35 | 675 | 0.69 | 41 | 15 | 4% |
| | Xerogel | | | | | | |
| 5 | Xerogel A | 2.5 | 300 | 1.55 | 207 | 8.7 | 38% |
| 6 | Xerogel B | 3.8 | 438 | 1.28 | 116 | 13.08 | 43% |

As can be seen, at a dosing concentration of 20 g agent/100 L wort (conventional finings dosage), a significant reduction in haze was observed for examples 1-6 compared to the corresponding comparative examples.

### Haze Reduction and Sensitive Protein Reduction Using Low Water Content Silica Particles of Different Pore Volumes (Examples 7-21)

A sample of a wort was obtained during transfer from a wort kettle to a whirlpool as described above. The wort was wort 1 as described above. The wort was then treated with a range of low water content silica particles at a concentration of 20 g/hl. The silica particles tested included xerogels and precipitated silicas. The haze reduction after 20 mins and the sensitive protection content reduction after 30 mins was measured as described in the methods section above. The results are shown in the table 2.

TABLE 2

| | | | | | | | | Sensitive |
|---|---|---|---|---|---|---|---|---|
| | | | | | | | Haze | Protein |
| | | Water | Surface | Pore | Pore | | reduction | reduction |
| | Silica | Content | Area | Volume | Diameter | D(50) | (EBC 90°) | (EBC) |
| | Description | % | (m2/g) | (ml/g) | (Å) | (μm) | 20 min | 30 min |
| C10 | No Silica | N/A | N/A | N/A | N/A | N/A | 0% | 0% |
| 7 | Xerogel 1 | 3.86 | 327 | 1.17 | 143 | 7.16 | 43% | 9% |
| 8 | Xerogel 2 | 3.82 | 331 | 1.17 | 142 | 9.79 | 35% | 28% |
| 9 | Xerogel 3 | 4.06 | 342 | 1.17 | 137 | 14.74 | 38% | 16% |
| 10 | Xerogel 4 | 2.71 | 268 | 1.71 | 255 | 7.41 | 43% | 31% |
| 11 | Xerogel 5 | 2.75 | 263 | 1.69 | 256 | 9.52 | 48% | 39% |
| 12 | Xerogel 6 | 3.49 | 265 | 1.72 | 260 | 15.15 | 46% | 27% |
| 13 | Xerogel 7 | 4.88 | 291 | 1.50 | 207 | 7.44 | 43% | 25% |
| 14 | Xerogel 8 | 5.76 | 295 | 1.54 | 209 | 9.24 | 31% | 44% |
| 15 | Xerogel 9 | 7.21 | 722 | 0.50 | 27 | 6.91 | 36% | 0% |
| 16 | Xerogel 10 | 7.09 | 726 | 0.50 | 27 | 10.37 | 29% | 0% |
| 17 | Xerogel 11 | 7.14 | 746 | 0.51 | 27 | 15.08 | 33% | 4% |
| 18 | Precipitated | 5.66 | 423 | 1.08 | 102 | 6.97 | 41% | 14% |
| | silica 1 | | | | | | | |
| 19 | Precipitated | 5.51 | 423 | 1.09 | 103 | 9.47 | 41% | 9% |
| | silica 2 | | | | | | | |
| 20 | Precipitated | 5.49 | 440 | 1.1 | 100 | 15.46 | 28% | 31% |
| | silica 3 | | | | | | | |
| 21 | Xerogel 12 | 3.8 | 438 | 1.28 | 116 | 13.08 | 41% | 13% |

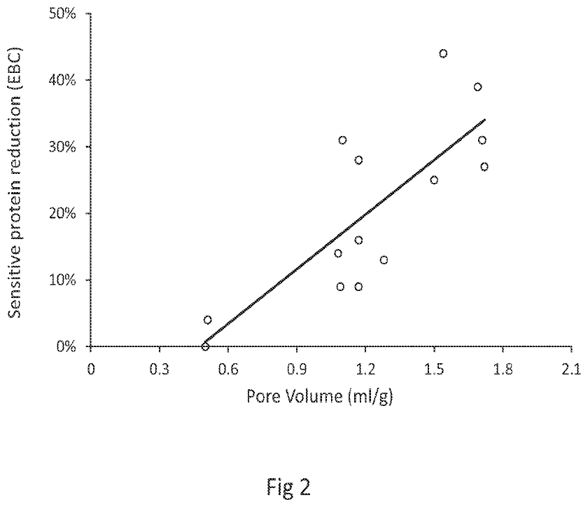

As can be seen in the data above, silica particles according to the invention showed a significant reduction in the haze compared to the untreated wort. It is also evident that higher pore volumes showed improved protein reduction compared to inventive silicas with lower pore volumes. For example, examples 10-12 with a pore volume of 1.72 ml/g showed a protein reduction of at least 27%, while examples 15-17 with a pore volumes of 0.51 ml/g showed a maximum of 4% reduction. This is shown graphically in FIG. 2, which shows a correlation between the pore volume and the sensitive protein reduction

### Haze Reduction on Worts after Treatment with Various Silica Xerogels (Examples 22-30)

Samples from two different worts were obtained during transfer from a wort kettle to a whirlpool as described above. The first wort was at 15-16°P of a pure malt beer (wort 2 above). The second wort was a 60% malt and 40% adjuncts at 18-18.5° P (wort 3 above). Each wort was then treated with different silica xerogel particles (xerogels 12 to 15) at a concentration of 20 g/hl. The haze level after 20 mins was measured as described in the methods section above. The volume of trub was also measured after 20 mins. The results are shown in the table 3.

TABLE 3

| | | | | | | | |
|---|---|---|---|---|---|---|---|
| | | | | | | Haze | |
| | Water | Surface | Pore | Pore | | reduction | Trub |
| Silica | Content | Area | Volume | Diameter | D(50) | (EBC 90°) | (ml) |
| Description | % | (m2/g) | (ml/g) | (Å) | (μm) | 20 mins | 20 mins |

Pure malt wort

| | | | | | | | | |
|---|---|---|---|---|---|---|---|---|
| C11 | No silica | N/A | N/A | N/A | N/A | N/A | 0% | 90 |
| 22 | Xerogel 12 | 3.8 | 438 | 1.28 | 116 | 13.08 | 54% | 62 |
| 23 | Xerogel 13 | 3.4 | 470 | 1.28 | 109 | 20 | 47% | 60 |
| 24 | Xerogel 14 | 3.5 | 681 | 1.22 | 72 | 12 | 47% | 60 |
| 25 | Xerogel 15 | 3.7 | 494 | 1.27 | 103 | 37.8 | 42% | 62 |

60% malt, 40% adjuncts wort

| | | | | | | | | |
|---|---|---|---|---|---|---|---|---|
| C12 | No silica | N/A | N/A | N/A | N/A | N/A | 0% | 190 |
| 24 | Xerogel 12 | 3.8 | 438 | 1.28 | 116 | 13.08 | 86% | 90 |
| 25 | Xerogel 13 | 3.4 | 470 | 1.28 | 109 | 20 | 85% | 90 |
| 26 | Xerogel 14 | 3.5 | 681 | 1.22 | 72 | 12 | 86% | 85 |
| 27 | Xerogel 15 | 3.7 | 494 | 1.27 | 103 | 37.8 | 84% | 85 |

As evidenced above, the use of silica particles is applicable to both pure malts and mixed malts. A clear reduction is haze is obtained in all cases along with a more compact trub.

### Dosage Levels (Examples 28-30)

Experiments were conducted to confirm the effect on haze reduction of the dosage of silica particles relative to the wort. Samples of a wort were obtained during transfer from a wort kettle to a whirlpool as described above. The wort was a brew at 15-16°P of a pure malt beer (wort 2 above). Silica xerogel particles were then added at a concentration of 10 g/hl, 20 g/hl and 30 g/hl and the haze level and sensitive protein reduction was measured as described in the methods section above.

The results are shown in table 4

TABLE 4

| | | | | | | | | | Sensitive |
|---|---|---|---|---|---|---|---|---|---|
| | | | | | | | | Haze | Protein |
| | | Dosage | Water | Surface | Pore | Pore | | reduction | reduction |
| | Silica | level | Cont. | Area | Vol. | Diameter | D(50) | (EBC 90°) | (EBC) |
| | Description | (g/hl) | % | (m2/g) | (ml/g) | (Å) | (μm) | 20 mins | 30 min |
| C13 | No silica | N/A | N/A | N/A | N/A | N/A | N/A | 0% | 0% |
| 28 | Xerogel 12 | 10 | 3.8 | 438 | 1.28 | 116 | 13.08 | 40% | 5% |
| 29 | Xerogel 12 | 20 | 3.8 | 438 | 1.28 | 116 | 13.08 | 42% | 11% |
| 30 | Xerogel 12 | 30 | 3.8 | 438 | 1.28 | 116 | 13.08 | 45% | 27% |

As can been seen in the experiments above, even at only 10 g dosage, the inventive silica particles were able to achieve the majority of haze reduction obtainable at 20 g/hl or 30 g/hl loadings, showing excellent efficiency, and indicating that even lower levels could be used in practice. The reduced silica content is moreover expected to result in downstream processing benefits since less finings material must be removed from the beverage product.

### Silica Gels with Different Particle Sizes and Pore Volumes (Examples 31 and 32)

Two experiments were conducted to analyse the effect of varying particle size or using very high pore volume silica gels on the haze and sensitive protein reduction. Samples of a wort were obtained during transfer from a wort kettle to a whirlpool as described above. The wort was 60% malt and 40% adjunct (wort 3 as described above). Silica particles were then added at a concentration of 20 g/hl and the haze level and sensitive protein reduction was measured as described in the methods section above. The results are shown in table 5.

TABLE 5

| | | | | | | | | | Sensitive |
|---|---|---|---|---|---|---|---|---|---|
| | | | | | | | | Haze | Protein |
| | | Dosage | Water | Surface | Pore | Pore | | reduction | reduction % |
| | Silica | level | Cont. | Area | Vol. | Diameter | D(50) | (EBC 90°) | (EBC) |
| | Description | (g/hl) | % | (m2/g) | (ml/g) | (Å) | (μm) | 20 min | 30 min |
| C13 | No silica | N/A | N/A | N/A | N/A | N/A | N/A | 0% | 0% |
| 29 | Xerogel 12 | 20 | 3.8 | 438 | 1.28 | 116 | 13.08 | 42% | 11% |
| 31 | Xerogel 16 | 20 | 3.9 | 331 | 1.25 | 151 | 90-106 | 25% | 0% |
| 32 | Xerogel 17 | 20 | 3.4 | 423 | 1.82 | 173 | 15.49 | 31% | 2% |

As can been seen in the experiments above, all the inventive silica samples showed a significant reduction in the haze, however xerogel 12 (example 29) outperformed xerogels 16 and 17 (examples 31 and 32 respectively) in terms of both haze and protein reduction.

### Industrial Scale Examples (Example 33)

The use of porous silica particles during the production of 60% malt and 40% adjuncts brew beer was tested as described in the method section above.

Table 6 shows the results of measurements on the filter unit while filtering the fermented beer obtained from a reference brew of the 40% adjuncts beer and an equivalent brew employing the silica xerogel particles. Both the reference brew and the brew employing silica particles were split into two tanks (C15-1/C15-2 & Example 33-1/33-2 respectively) and the pressure differential in the filter was measured automatically by the filtration equipment. The properties of the silica xerogel particles used were identical to those provided in example 21 above (xerogel 12).

TABLE 6

| | | | Volume | ΔP per | |
|---|---|---|---|---|---|
| | | Dosage | of beer | 100 hl | |
| | Silica | level | filtered | beer | |
| | Description | (g/hl) | (hL) | filtered | ΔP - Filter |
| C15-1 | No silica | N/A | 600 | 0.117 | +0.7b |
| C15-2 | No silica | N/A | 1150 | 0.122 | +1.4b |
| 33-1 | Xerogel 12 | 20 | 1200 | 0.025 | +0.3b |
| 33-2 | Xerogel 12 | 20 | 950 | 0.011 | +0.1b |

As can be seen from the data, the brew employing the silica particles according to the invention had a lower charge on the filter than the reference brew (according to values for ΔP per 100 hl). In particular, example 33-1 was able to filter twice as much beer with half the pressure change compared to comparative example C15-1.

Although the present invention has been described in detail, it should be understood that various changes, substitutions, and alterations are contemplated without departing from the principle and scope of the invention. Accordingly, the scope of the present invention defined herein and particularly the following claims should be interpreted in consideration of the appropriate equivalents. The terms “a”, “an” and “the” do not preclude the presence of multiple referents, unless the context clearly dictates otherwise. Optional or optionally means that the feature or activity may or may not be present. Either is contemplated. In embodiments, the optional feature or features may be present. Alternatively, the optional feature or features may not be present. Ranges may be expressed herein as “from” one particular value, and/or “to” another particular value, which is intended to be inclusive of the end-points of the range.

1. Use of porous silica gel particles or porous precipitated silica particles in treating a wort, wherein the porous silica particles have a water content of 30% by weight or less and a pore volume of 0.4 ml/g or more.

2. The use according to claim 1, wherein the porous silica particles have a pore volume of 0.75 ml/g or more, or wherein the porous silica particles have a pore volume of 1 ml/g or more, optionally wherein the porous silica particles have a pore volume of 1.5 ml/g or more.

3. (canceled)

4. The use according to claim 1, wherein the porous silica particles have a pore volume of 2 ml/g or less, optionally wherein the porous silica particles have a pore volume of 1.8 ml/g or less.

5. The use according to claim 1, wherein the porous silica particles have a water content of 20% by weight or less, or 10% by weight or less, preferably 5% by weight or less.

6. (canceled)

7. The use according to claim 1, wherein the porous silica particles are porous silica gel particles.

8. The use according to claim 7, wherein the porous silica gel particles are porous silica xerogel particles.

9. The use according to claim 1, wherein the porous silica particles have a surface area of 800 m²/g or less, optionally 500 m²/g or less.

10. (canceled)

11. The use according to claim 1, wherein the porous silica particles are used in an amount of 1 g to 50 g per 100 litres of wort, optionally 10 g to 30 g per 100 litres of wort

12. The use according to claim 11, wherein the porous silica particles used in an amount of no more than 25 g per 100 litres of wort, optionally 20 g per 100 litres of wort.

13. The use according to claim 1, wherein the porous silica particles have a weight median particle diameter (D50) of 1 μm or more, optionally 5 μm or more.

14. The use according to claim 1, wherein the porous silica particles have a weight median particle diameter (D50) of 200 μm or less, 150 μm or less, 100 μm or less, 80 μm or less, optionally 50 μm or less.

15. A method of treating a wort comprising:
contacting the wort with porous silica gel particles or porous precipitated silica particles;
wherein the porous silica particles have a water content of 30% by weight or less and a pore volume of 0.4 ml/g or more.

16. The method according to claim 15, wherein contacting the porous silica particles with the wort occurs within a mash tun, a lauter tun, a press filter, a wort kettle, a whirlpool/decanter or a fermenter, or between any two of the above.

17. The method according to claim 15, further comprising allowing the silica particles to settle out of the wort and separating the wort from the silica particles.

18. The method according to any of claim 15, further comprising using the wort to produce a beverage.

19. A method of preparing a beverage comprising:
treating grains to produce a wort;
contacting the wort with porous silica gel particles or porous precipitated silica particles; and
using the resulting wort to produce the beverage,
wherein the porous silica particles have water content of 30% by weight or less and a pore volume of 0.4 ml/g or more.

20. The method according to claim 19, further comprising separating the silica particles from the wort prior to using the wort to produce the beverage.

21. The method according to claim 20, wherein the porous silica particles are separated from the wort together with spent grains produced from treating the grains.

22. The method according to any of claim 19, wherein
the method of preparing a beverage is a method of brewing a fermented beverage and comprises:
treating grains to produce a wort;
contacting the wort with porous silica gel particles or porous precipitated silica particles; and
fermenting the wort to produce the fermented beverage.

23. The method according to claim 22, wherein the fermented beverage is a beer.
